(19) United States
(12) Patent Application Publication
(10) Pub. No.: US 2006/0125220 A1
(43) Pub. Date: Jun. 15, 2006

(54) Airbag module, especiallly a passenger airbag module

(75) Inventors: Detlef Crohn, Berlin (DE); Sven Ortmann, Fredersdorf (DE); Gerhard Lutter, Bergfelde (DE); Thomas Marotzke, Bergfelde (DE)

Correspondence Address: FOLEY AND LARDNER LLP;SUITE 500, 3000 K STREET NW, WASHINGTON, DC, 20007, US

(73) Assignee: TAKATA-PETRI AG, 63743 Aschaffenburg (DE)

(21) Appl. No.: 10/530,295

(22) PCT Filed: Sep. 25, 2003
(86) PCT No.: PCT/DE03/03266

§ 371 Date: Nov. 10, 2005

(30) Foreign Application Priority Data
Oct. 7, 2002 (DE) 102 47 395.1

(51) Int. Cl. B60R 21/26

(52) U.S. Cl. 280/742; 280/740

(57) ABSTRACT

The invention relates to an airbag module, especially a passenger airbag module, comprising a gas generator arranged in a module housing. The aim of the invention is to create an airbag module which provides the gas bag with a sufficient retaining capacity and enables a load-reducing gas bag deployment which can be variably influenced. According to the invention, the module housing (1) comprises a continuous gas outlet (6) on at least one side in the region of a gas bag (4) to be deployed, and at least one section (7) extending into the gas bag (4) is arranged in the region of the gas outlet. Alternatively, the section (11) can be arranged directly above the gas outlet (6a; 6b).

The invention relates to an airbag module, especially a passenger airbag module, according to the precharacterizing clause of claim 1.

In order to minimize negative effects on the occupants of a vehicle when airbags are triggered and in order to ensure a reproduceable functioning of the airbag module, measures are required for the specifically controlled deployment of the airbag.

For this, in addition to structural measures on the airbag structural measures on the airbag module are also known. Thus, WO 96/25309 discloses an airbag module, in which a chimney-like diffuser extends into the airbag. Only one layer of the airbag is situated above the chimney. The diffuser has enlarged discharge openings in the desired main direction of deployment. The effect achieved by this is that the airbag has an enlarged surface expansion in this direction.

The disadvantage of this arrangement is that the walls of the diffuser have to be arranged at a distance from one another in order to permit the gases to flow through. As a result, the space available for the airbag in the airbag module is limited, which, particularly in the case of restricted installation conditions, results overall in a high packing density.

Japanese laid-open specification 09048318 A discloses an airbag arrangement with a tubular gas generator. A diffuser which has a web extending into the airbag is provided in this airbag arrangement. The diffuser and the web are manufactured as a sheet-metal part from a single piece, and extend over the entire length of the tubular gas generator, the web running in the center of the diffuser in the direction of the longitudinal axis of the tubular gas generator. To the side of the web and at a distance therefrom there are a plurality of discharge openings in the diffuser, with larger discharge openings being provided on one side of the web than on the other side, or there being discharge openings only on one side. The airbag is mounted above the diffuser and in both sides of the web. After ignition of the gas generator, the airbag is deployed more rapidly on the side with the larger discharge openings than on the other side. At the same time, the direction of deployment is also affected as a result.

This arrangement does indeed give the airbag package a relatively large retaining capacity. However, because of the discharge openings which are provided at a distance from the web, the path of the gases into the airbag region situated above the web is obstructed. The gases first of all spread out below the airbag package. This gives rise to the effect that, at the beginning of the deployment of the airbag, the airbag regions arranged on both sides of the web are suddenly pushed out of the module housing, which may lead to increased loads on the occupant.

The invention is based on the object of providing an airbag module which provides the airbag with a sufficient retaining capacity and permits a load-reducing airbag deployment which can be variably influenced.

This is achieved according to the invention by the features of claim 1 or 2.

According to the invention, in the case of an airbag module, especially a passenger airbag module, having a gas generator which is arranged in a module housing, the module housing has a continuous gas outlet opening on at least one side in the region of an airbag to be deployed and at least one web extending into the airbag is arranged in the region of the gas outlet opening. The folded airbag extends primarily to the side of the web.

This arrangement has the advantage that the gases are conducted directly along the web into the airbag region situated above it because of the arrangement of the web in the region of the gas outlet opening. A pushing-out of the entire airbag package is avoided, and the airbag is deployed radially outward starting from this region. The outlay on manufacturing is reduced because of the single opening in the module housing. The different arrangement of the web in the region of the gas outlet opening enables the deployment of the airbag to be influenced in diverse ways. The combination of the features according to the invention therefore brings about an improvement both in the outlay on manufacturing and also in the possibility of influencing the deployment of the airbag. The retaining capacity for the airbag is only insignificantly limited by the web.

In order to influence the deployment, the web can run directly on the edge of the gas outlet opening. Furthermore, the web may also be arranged above the gas outlet opening. In this case, it may run in different directions above the gas outlet opening in accordance with the required deployment characteristics of the airbag, and may be arranged at any desired location above the gas outlet opening.

The object is also achieved by an airbag module, especially a passenger airbag module, having a gas generator which is arranged in a module housing, in which the module housing has at least one gas outlet opening on at least one side in the region of an airbag to be deployed, and in which at least one web extending into the airbag is arranged directly above the gas outlet opening. In this case too, the web can run in different directions and can be arranged at any desired location.

The web preferably has a smaller length than the space in the module housing part for the mounting of the folded airbag, and the web extends almost as far as the upper edge of the module housing.

In one preferred embodiment, the module housing is of two-part design, the gas outlet opening and the web being provided on a first part, also referred to as lower part, in which the gas generator is arranged, the folded airbag being arranged in a second part, also referred to as upper part, and both parts being connected via flanges between which the blow-in mouth of the airbag is fixed.

When a tubular gas generator is used, the gas outlet opening runs in the direction of its longitudinal axis. In this embodiment, the web may run both in the direction of the longitudinal axis of the tubular gas generator or transversely to the tubular gas generator or obliquely with respect to the direction of the longitudinal axis. As a result just of this, the deployment of the airbag can be widely influenced. The position of the web is selected in such a manner that the packing density of the airbag can be set in accordance with the desired deployment.

In addition, the deployment may be influenced by different cross sections of the web. In one embodiment, the web has a rectangular cross section. In a further embodiment, the web has a wave-shaped cross section. In addition to an increased stiffness, the wave shape has the advantage of facilitating the conducting of the gas flow into the upper fabric layer, since there is a distance between the folded airbag and the web in the wave troughs and a gas passage thus remains free.

The shape and the profile of the web may also have an influence on the deployment. Thus, in one embodiment, the web is of bow-shaped design, it being possible for this web to be fastened to the module housing on opposite sides of the gas outlet opening or on one side of the gas outlet opening.

In a further embodiment, the web is angled in such a manner that it at least partially covers the gas outlet opening. This enables the gas flow to be deflected in a desired direction, and a direct streaming of it against the upper fabric layer of the airbag is avoided or reduced.

In a further embodiment, the web has channels for conducting the gas flow. In one embodiment, the channels run rectilinearly, in which case they run on the outlet side in such a manner that they are directed onto the airbag layer situated above the web and therefore conduct the gas flow preferably in the direction of this airbag layer. In a further embodiment, the channels on the outlet side of the gases run in a different direction than the channels on the inlet side, the outlets of the channels preferably ending on the end sides of the web.

The invention will be explained in exemplary embodiments with reference to the drawings, in which:

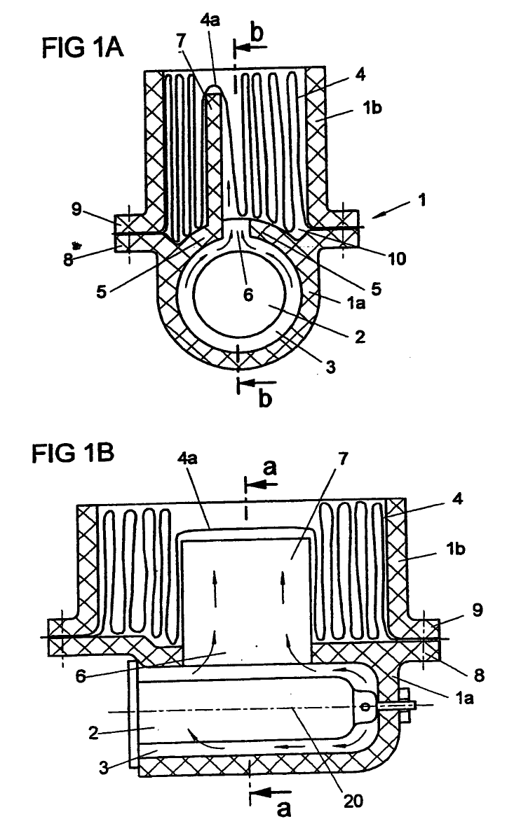

FIG. 1A shows a cross section through a passenger airbag module;

FIG. 1B shows a longitudinal section through the passenger airbag module according to FIG. 1;

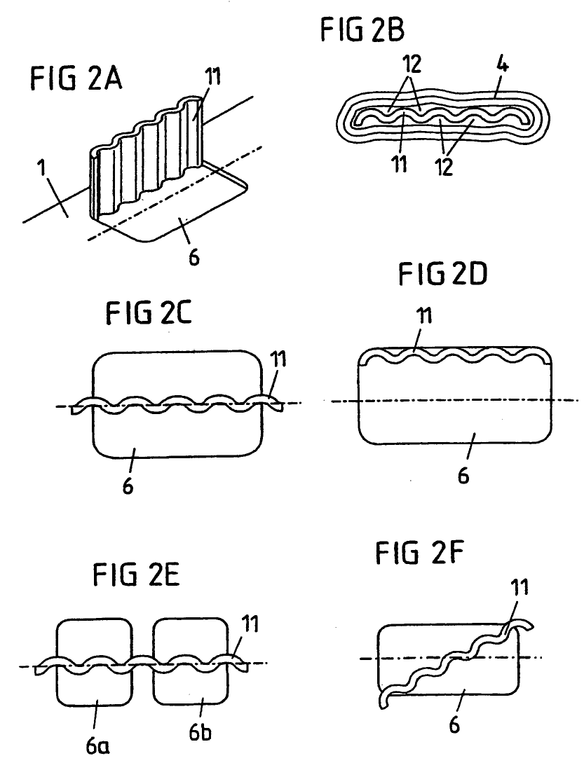

FIGS. 2A-2F show embodiments with wave-webs;

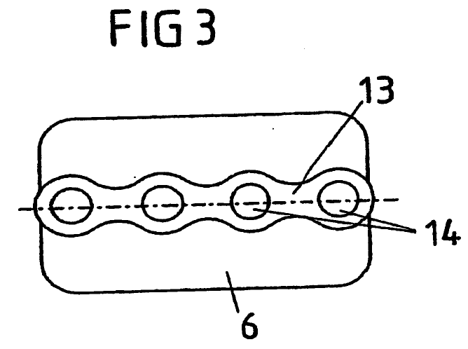

FIG. 3 shows an embodiment with channels running rectilinearly in the web;

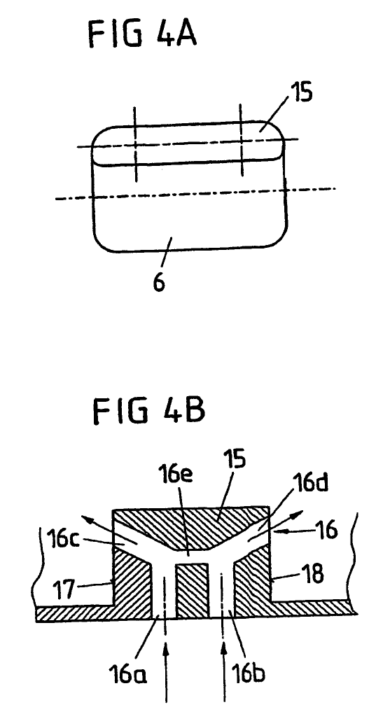

FIGS. 4A, 4B show an embodiment with angled channels in the web;

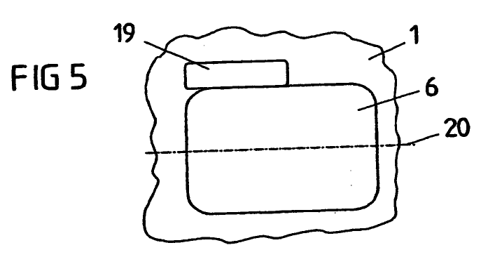

FIG. 5 shows an embodiment with a straight web;

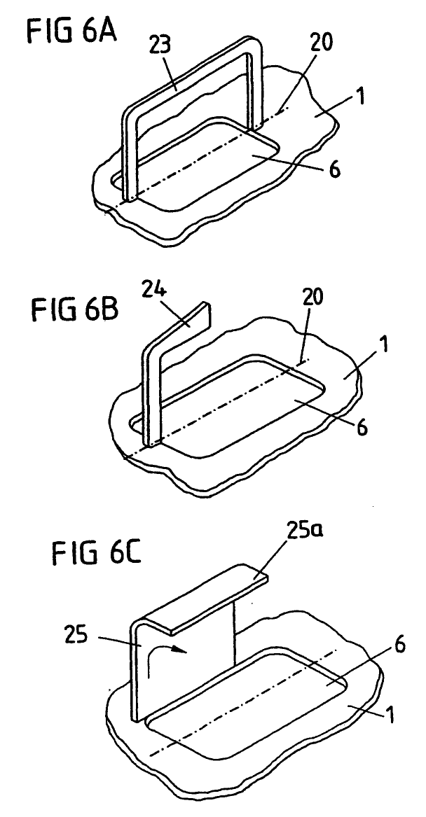

FIGS. 6A, 6B show embodiments with bow-shaped webs;

FIG. 6C shows an embodiment with an angled web.

FIGS. 1A and 1B illustrate a two-part module housing 1 which comprises a first part 1a, which can also be referred to as lower part, and a second part 1b, which can also be referred to as upper part. The lower part 1a of the housing is used for accommodating a tubular gas generator 2 and for the separation between a pressure space 3, which is formed in the lower part of the housing, and a folded airbag 4, also referred to as airbag package, which is arranged in the upper part 1b of the housing. The separating wall region 5 of the lower part 1a of the housing is provided with a continuous gas outlet opening 6 via which the gases emerging from the tubular gas generator 2 are conducted into the airbag 4. A web 7 which projects into a fold of the airbag package is arranged to the side of the gas outlet opening. Said web runs from the separating wall region 5 almost as far as the upper edge of the upper part 1b of the housing and therefore as far as the upper edge of the module housing 1. Only one airbag layer 4a is situated above the web 7 while the folded airbag is mounted next to the web 7. The lower part 1a of the housing has an encircling flange 8 and the upper part of the housing has an encircling flange 9. The housing parts 1a and 1b are connected to each other by means of these flanges. The airbag 4 is also fixed in the region of its blow-in mouth 10 between these flanges.

The web 7 partially separates the airbag package 4, since it does not extend over the entire length of the upper part 1b of the housing. As can be seen from FIG. 1A, there is a narrower space for the folded airbag on the left-hand side, next to the web 7, in the direction of the longitudinal axis of the tubular gas generator 2 than on the right-hand side, as a result of which, with at least approximately the same amount of airbag on both sides, a different packaging density can be obtained and therefore the deployment can be influenced. It can thus be seen in FIG. 1A that the packaging density on the left-hand side is greater than on the right-hand side. Since the gas outlet opening 6 is also situated on the right-hand side of the web 7, the airbag is first of all deployed on the right-hand side of the web, the gas flow being conducted by the arrangement of the web 7 in a specific manner into the upper airbag layer 4a.

In the following figures, of the module housing 1 only the gas outlet opening 6 is illustrated in order to explain the different arrangement thereof with respect to the web and the different shapes of the web.

Thus, FIG. 2A illustrates, on the edge of the gas outlet opening 6, a web 11 having a wave-shaped cross section. In addition to an increased stiffness, the wave shape has the advantage of facilitating the conducting of the gas flow into the upper airbag layer (not illustrated in this figure). As can be seen from the plan view of FIG. 2B, there is a distance in the wave troughs 12 between the airbag package 4 and the web 11, thus enabling gas passages to remain free.

FIG. 2C illustrates an embodiment in plan view, in which the wave-shaped web 11 is arranged in the center of the gas outlet opening 6. With this embodiment, a different packaging density on both sides of the web can be obtained if the gas outlet opening 6 is not arranged centrally, as illustrated in FIG. 1A.

FIG. 2D shows a plan view of the embodiment of FIG. 2A.

FIG. 2E shows a variant in which two gas outlet openings 6a, 6b are provided. The wave-shaped web 11 runs centrally above the latter.

Finally, FIG. 6F illustrates an embodiment in which the wave-shaped web 11 is arranged obliquely above the gas outlet opening 6.

FIG. 3 shows an arrangement in plan view, in which a web 13 is provided with channels 14. The latter run rectilinearly from the gas inlet on the lower side of the web to the gas outlet on the upper side of the web, in the direction of the upper airbag layer, which is not illustrated in this figure. The web 13 is arranged centrally above the gas outlet opening 6. The channels permit an additional influencing of the deployment of the airbag.

FIGS. 4a and 4b show a web 15 having channels 16. This web is arranged to the side of the gas outlet opening 6. In this embodiment, the channels do not run rectilinearly, but rather diverge in the web 15. At the gas inlet there are parallel channels 16a, b which merge in the center of the web 15 into channels 16c, d running obliquely to the lateral end walls 17, 18. These channels also emerge from the web 15 at the abovementioned end walls. In addition, a connecting channel 16e is also formed.

In this embodiment too, the gases emerging from the gas generator are conducted to the upper airbag layer. The oblique orientation of the gas flow constitutes an additional possibility for influencing the deployment of the airbag.

In FIG. 5, a web 19 is arranged directly on the edge of the gas outlet opening 6 parallel to the longitudinal axis 20 of a tubular gas generator (not illustrated). In this embodiment, the web 19 is shorter than the gas outlet opening. The web is fastened to the module housing 1, only part of which is illustrated in this figure.

FIG. 5 shows just one possibility for arranging the web. The packing density and therefore the desired deployment characteristics can be set by means of different lengths and other positions of the web with respect to the gas outlet opening.

FIGS. 6A-C illustrate further, alternative embodiments of webs as an addition to FIGS. 2 and 3. FIG. 6A shows a bow-shaped web 23 which extends in the direction of the longitudinal axis 20 of the gas generator (not illustrated). This web spans the gas outlet opening 6 in the center thereof and is fastened at its opposite edges to the module housing 1.

In the case of the exemplary embodiment of FIG. 6B, a bow-shaped web 24 is provided, which web likewise extends in the direction of the longitudinal axis 20 of the gas generator, that is fastened to the module housing 1 only on one side of the gas outlet opening 6 and extends only approximately as far as the center of the gas outlet opening 6.

In the embodiment of FIG. 6C a web 25 which is angled in the upper region is provided. The angled section 25a partially covers the gas outlet opening 6 in FIG. 6C. However, this section may also be dimensioned in such a manner that it completely covers the gas outlet opening. The partial or complete covering enables the gas flow to be deflected in a desired direction and reduces or avoids a direct streaming of it against the upper airbag layer.

The invention is not restricted to the embodiments illustrated in the figures. Thus, the webs may have other shapes and may be arranged at other locations. Furthermore, a plurality of webs may also be provided.

1-22. (canceled)

23. A passenger airbag module comprising:
a gas generator arranged in a module housing;
wherein the module housing includes a space containing a folded airbag and includes a gas outlet opening on a side of the housing adjacent the airbag;
wherein the housing includes a web located on a side of the gas outlet opening, wherein the web extends into the folded airbag.

24. The airbag module of claim 23, wherein the web extending into the airbag is arranged directly above the gas outlet opening.

25. The airbag module of claim 23, wherein the length of the web along the side of the gas outlet opening is shorter than the space in the module housing for the folded airbag, and wherein the web extends away from the opening to a position adjacent an upper edge of the module housing.

26. The airbag module of claim 23, wherein the airbag is folded so that there is only one airbag layer above the web.

27. The airbag module of claim 25, wherein the module housing includes two-parts, the gas outlet opening and the web being provided on a first part, in which the gas generator is arranged, the folded airbag being arranged in a second part, and both parts being connected via flanges between which a blow-in mouth of the airbag is fixed.

28. The airbag module of claim 23, wherein the gas generator is tubular and the gas outlet opening runs in the direction of the longitudinal axis of the gas generator.

29. The airbag module of claim 28, wherein the web extends in the direction of the longitudinal axis of the tubular gas generator.

30. The airbag module of claim 28, wherein the web extends transversely to the longitudinal axis of the tubular gas generator.

31. The airbag module of claim 28, wherein the web extends obliquely to the direction of the longitudinal axis of the tubular gas generator.

32. The airbag module of 23, wherein the web extends directly along the edge of the gas outlet opening.

33. The airbag module of claim 25, wherein the web is arranged above the gas outlet opening.

34. The airbag module of claim 23, wherein the web has a rectangular cross section.

35. The airbag module of claim 23, wherein the web has a wave-shaped cross section.

36. The airbag module of claim 23, wherein the web is bow-shaped.

37. The airbag module of claim 36, wherein the bow-shaped web is fastened to the module housing on opposite sides of the gas outlet opening.

38. The airbag module of claim 36, wherein the bow-shaped web is fastened to the module housing on one side of the gas outlet opening.

39. The airbag module of claim 23, wherein the web is angled so that the web at least partially covers the gas outlet opening.

40. The airbag module of claim 23, wherein the web has a plurality of channels having a plurality of outlets for conducting the flow of gas from the gas generator into the airbag.

41. The airbag module of claim 40, wherein the channels extend rectilinearly.

42. The airbag module of claim 40, wherein the outlets of the channels are positioned so that the gas flow is directed onto the airbag layer situated above the web.

43. The airbag module of claim 40, wherein the outlets of the channels extend in a different direction than the inlets of the channels.

44. The airbag module as claimed in claim 40, wherein the outlets of the channels are positioned to terminate on a plurality of sides of web.
